(19) United States
(12) Patent Application Publication
(10) Pub. No.: US 2022/0316512 A1
(43) Pub. Date: Oct. 6, 2022

(54) EXPANSION ANCHORING DEVICE

(71) Applicant: YOKE INDUSTRIAL CORP., Taichung City (TW)

(72) Inventors: CHIA-HSIEN WANG, Shengang Township (TW); CHI-MIN LIU, Taichung City (TW)

(73) Assignee: YOKE INDUSTRIAL CORP., Taichung City (TW)

(21) Appl. No.: 17/217,698

(22) Filed: Mar. 30, 2021

(51) Int. Cl. F16B 13/06

(52) U.S. Cl. CPC F16B 13/066

(57) ABSTRACT

An expansion anchoring device includes a sleeve having a through-hole, a core member, and a movable member disposed between the sleeve and the core member and partially located in the through-hole. The core member passing through the sleeve includes a connecting portion located out of the sleeve, an expansion portion, and a shaft portion connected to the connecting portion and the expansion portion. The expansion portion located in the sleeve includes a first end portion and a second end portion connected to the shaft portion. An outer diameter of the first end portion is greater than an outer diameter of the second end portion. When the expansion anchoring device is mounted in a recessing hole of a wall and the connecting portion is pulled, the expansion portion abuts against the movable member, making the movable member protrude out of the through-hole and abut against a hole wall of the recessing hole.

### BACKGROUND OF THE INVENTION

### Technical Field

The present invention relates generally to a building auxiliary equipment, and more particularly to an expansion anchoring device.

### Description of Related Art

A conventional expansion anchoring device is usually fixed in a bore in a detachable manner and is additionally connected to other objects. For example, some construction workers, police officers, and even common people can use the anchoring device to fix an object on the wall or ceiling, wherein the object could be, but is not limited to, a hanging ring, a safety equipment, a wall decoration, a fitness equipment, etc.

U.S. Pat. No. 7,011,281 B2 discloses an expansion bolt 10, wherein by exerting an external force to a ring 30, a central plug 14 is moved toward a neck 20, thereby an outer surface of the central plug 14 pushes the external plugs 16, 17 to expand outward to abut against a hole wall 64 of a bore 61 to fix the expansion bolt 10 in the bore. When the expansion bolt 10 is to be disassembled, a reverse external force is exerted (e.g. hammering a bush 62 with a tool 65 such as a chisel) to move the central plug 14 away from the neck 20, so that the external plugs 16, 17 radially move inward, and the expansion bolt 10 could be removed from the bore 61.

However, the external plugs 16, 17, the bushing 62, and the neck 20 of the aforementioned expansion bolt 10 are connected by a plurality of steel cables 22, resulting in a large number of parts in the overall structure, high manufacturing costs, and complicated assembling procedures. Furthermore, external dust particles easily adhere to a contact surface between the external plugs 16, 17 and the central plug 14, thereby affecting the smoothness that the external plugs 16, 17 move relative to the central plug 14. Therefore, the conventional expansion anchoring device still has room for improvement.

### BRIEF SUMMARY OF THE INVENTION

In view of the above, the primary objective of the present invention is to provide an expansion anchoring device, which could be easily assembled and be smoothly operated.

The present invention provides an expansion anchoring device including a sleeve, a core member, and at least one movable member, wherein the sleeve has at least one through hole penetrating through both of an inner peripheral surface and an outer peripheral surface of the sleeve. The core member passes through the sleeve in a way that the core member is movable in an axial direction of the sleeve, wherein the core member includes a connecting portion, an expansion portion, and a shaft portion connected to both of the connecting portion and the expansion portion. The connecting portion is located out of the sleeve. The expansion portion is located in the sleeve and includes a first end portion and a second end portion opposite to the first end portion. An outer diameter of the first end portion is greater than an outer diameter of the second end portion. The second end portion is connected to the shaft portion. The at least one movable member is disposed between the sleeve and the core member, wherein a part of the at least one movable member is located in the at least one through hole.

With the aforementioned design, the expansion anchoring device of the present invention has simpler components that could be easily and quickly assembled. Additionally, the sleeve could prevent the external dust or fine particles adhering between the at least one movable member and the core member of the expansion portion, which facilitates the movement of the overall structures more smoothly.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the expansion anchoring device according to an embodiment of the present invention;

FIG. 2 is a front view of FIG. 1;

FIG. 3 is a sectional simplified view along the 3-3 line in FIG. 2;

FIG. 4 is a sectional view along the 4-4 line in FIG. 2;

FIG. 5 is similar to FIG. 3, showing the movable member abuts against the hole wall of the recessing hole; and

FIG. 6 is similar to FIG. 4, showing a part of the movable member protrudes from the through hole of the sleeve.

### DETAILED DESCRIPTION OF THE INVENTION

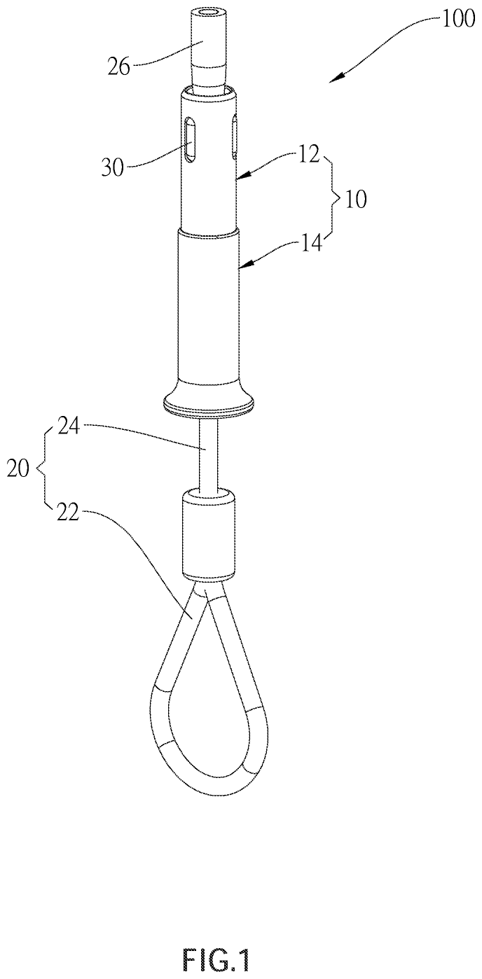

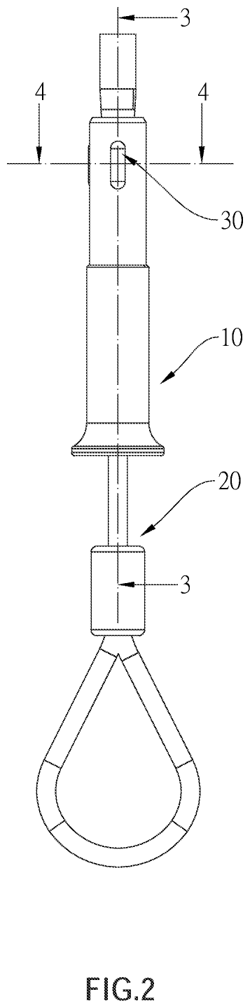

An expansion anchoring device 100 according to an embodiment of the present invention is illustrated in FIG. 1 to FIG. 6 and is adapted to be engaged with a recessing hole 200a of a wall 200 for being connected to other objects, wherein the expansion anchoring device 100 includes a sleeve 10, a core member 20, and at least one movable member 30.

The sleeve 10 includes a first tube body 12 and a second tube body 14, wherein the first tube body 12 has an annular recess 121 recessed into an outer peripheral surface of the first tube body 12, and the second tube body 14 has an annular protrusion 141 protruding from an inner peripheral surface of the second tube body 14. The annular protrusion 141 of the second tube body 14 is disposed in the annular recess 121 of the first tube body 12, thereby detachably engaging the second tube body 14 and the first tube body 12.

The first tube body 12 of the sleeve 10 has a shoulder portion 122 and at least one through hole 124, wherein the shoulder portion 122 is located on an inner peripheral surface of the first tube body 12 and is adjacent to the annular recess 121. In the current embodiment, the at least one through hole 124 includes a plurality of through holes 124 arranged at regular intervals on a tube wall of the first tube body 12, wherein the through holes 124 penetrate through the inner peripheral surface and the outer peripheral surface of the first tube body 12 of the sleeve 10.

The core member 20 passes through the sleeve 10 in a way that the core member 20 can move along an axial direction of the sleeve 10. The core member 20 includes a connecting portion 22, a shaft portion 24, and an expansion portion 26, wherein the connecting portion 22 and the expansion portion 26 are respectively connected to two opposite ends of the shaft portion 24. The connecting portion 22 is located out of the sleeve 10 and is close to the second tube body 14 rather than the first tube body 12, wherein the connecting portion 22 is a ring structure for being connected to other objects such as rope or hook. The expansion portion 26 is located in the first tube body 12 of the sleeve 10, wherein an outer diameter of the expansion portion 26 is greater than an outer diameter of the shaft portion 24. More specifically, the expansion portion 26 includes a first end portion 262 and a second end portion 264 opposite to the first end portion 262, wherein the expansion portion 26 is connected to the shaft portion 24 via the second end portion 264, and the outer diameter of the expansion portion 26 gradually decreases in a direction from the first end portion 262 toward the second end portion 264. In the current embodiment, the outer diameter of the expansion portion 26 located between the first end portion 262 and the second end portion 264 proportionally decreases. However, this is not a limitation of the present invention, the outer diameter of the expansion portion 26 located between the first end portion 262 and the second end portion 264 could not proportionally decrease in other embodiments. It is worth mentioning that, an outer diameter of the first end portion 262 is greater than an outer diameter of the second end portion 264.

In the current embodiment, the at least one movable member 30 includes a plurality of movable members 30 disposed between the sleeve 10 and the core member 20, wherein each of the movable members 30 is in a capsule shape. A part of each of the movable members 30 is located in one of the through holes 124, while another part of the movable members 30 is located in the sleeve 10. Each of the movable members 30 is restricted by a hole wall of one of the through holes 124, so that the movable members 30 would not disengage from the first tube body 12 of the sleeve 10 radially outward. In addition, each of the movable members 30 is restricted by the core member 20 and the hole wall of one of the through holes 124, so that the movable members 30 would not disengage from the first tube body 12 of the sleeve 10 radially inward.

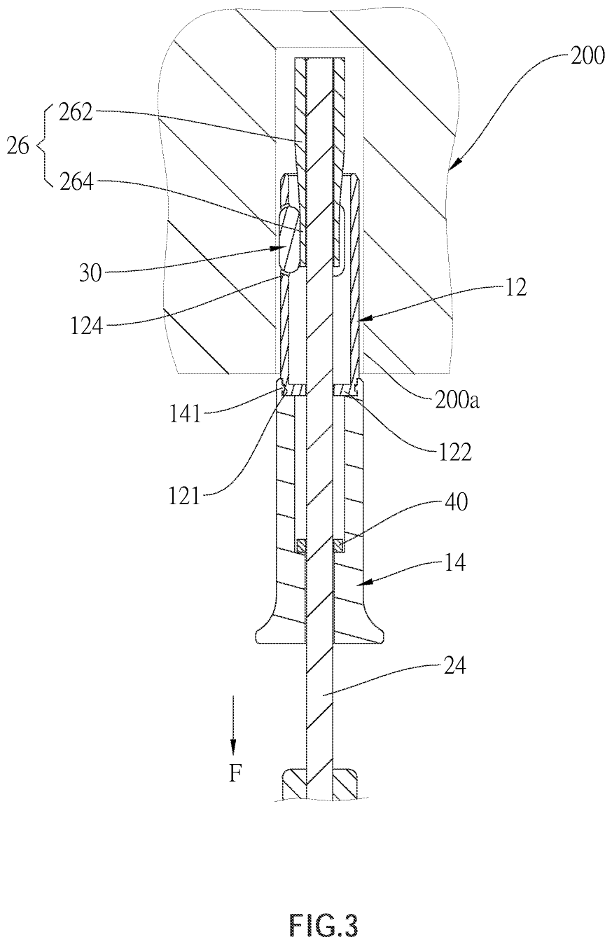

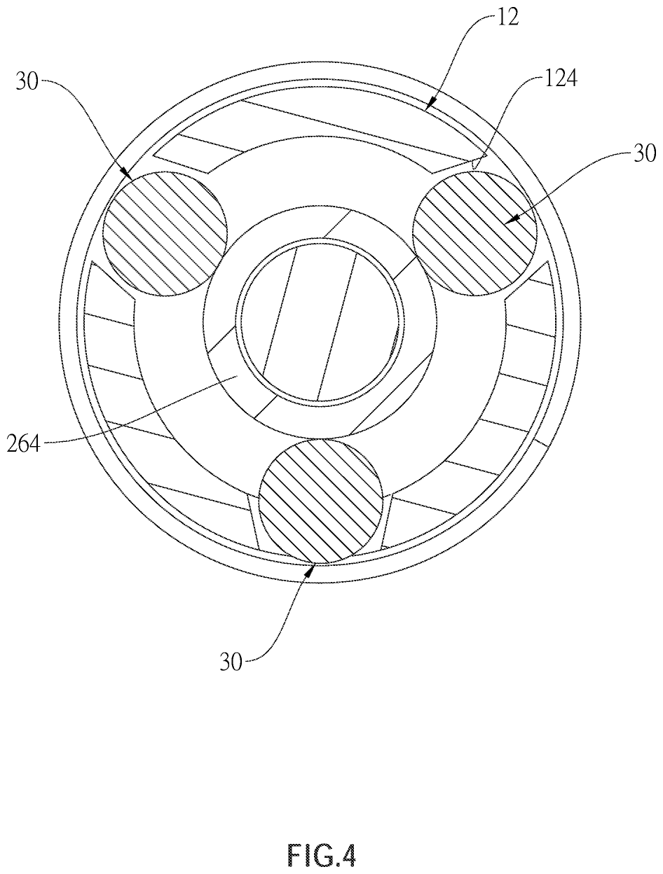

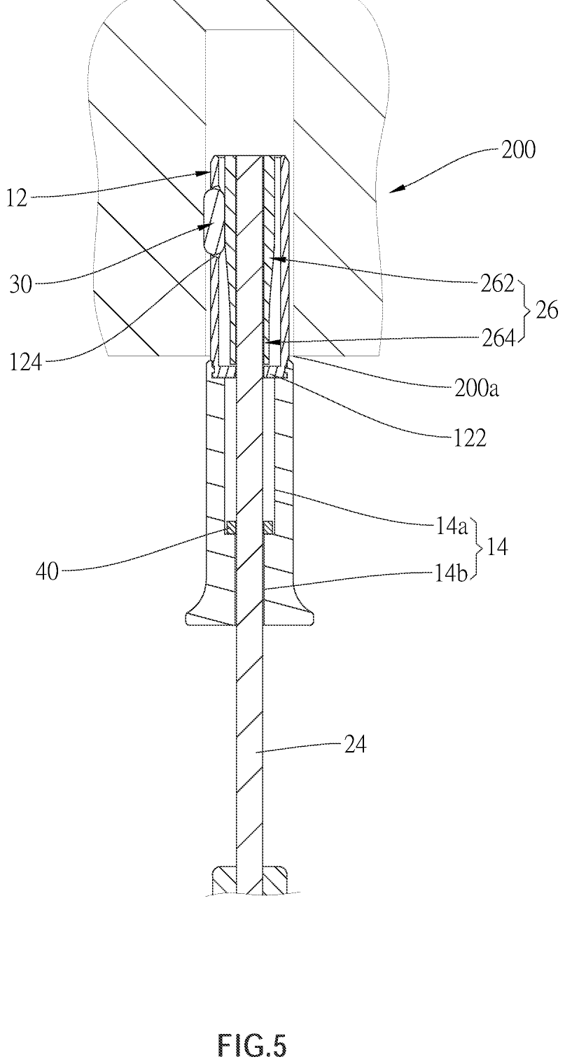

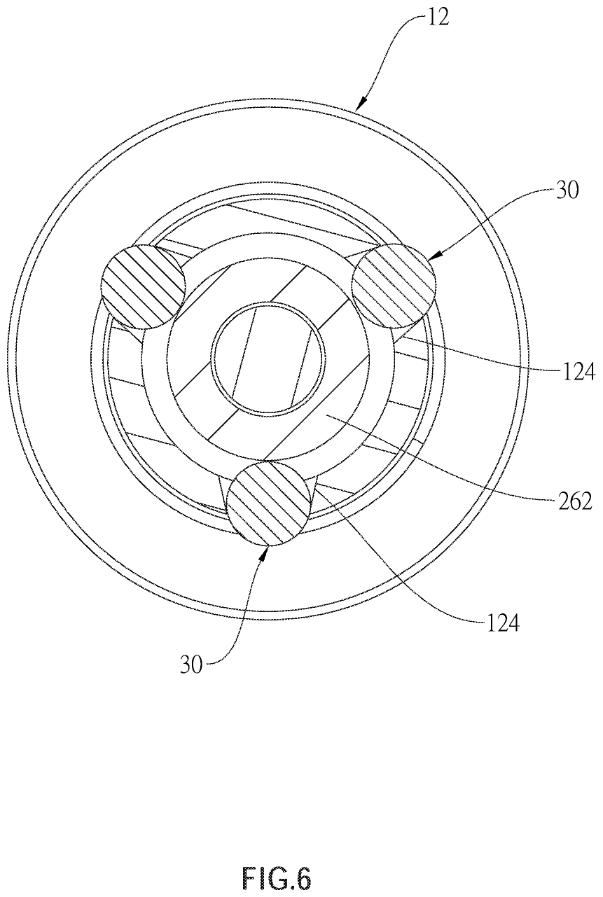

The movable member 30 includes a storage state and an expansion state. Referring to FIG. 3 and FIG. 4, when the second end portion 264 of the expansion portion 26 of the core member 20 corresponds to the through holes 124, the movable members 30 are in the storage state, wherein at this time, the movable members 30 could abut against the second end portion 264 of the expansion portion 26 to be almost entirely located in the first tube body 12 of the sleeve 10. Referring to FIG. 5 and FIG. 6, when the first end portion 262 of the expansion portion 26 of the core member 20 corresponds to the through holes 124, the movable members 30 are in the expansion state, wherein at this time, the movable members 30 could abut against the hole wall of the through holes 124 and the first end portion 262 of the expansion portion 26, thereby a part of the movable members 30 protrudes out of the first tube body 12 of the sleeve 10; in the meantime, the expansion portion 26 of the core member 20 could abut against the shoulder portion 122 of the sleeve 10, thereby positioning the core member 20 and ensuring that the first end portion 262 of the expansion portion 26 corresponds to the through holes 124.

More specifically, a diameter of each of the through holes 124 gradually increases from the outer peripheral surface of the first tube body 12 of the sleeve 10 toward the inner peripheral surface of the first tube body 12 of the sleeve 10, and at least a part of an outer contour shape of each of the movable members 30 corresponds to a shape of the hole wall of one of the through holes 124. In this way, when the second end portion 264 of the expansion portion 26 of the core member 20 corresponds to the through holes 124, each of the movable members 30 could unhindered slide toward the core member 20 along the hole wall of one of the through holes 124 to abut against the second end portion 264 of the expansion portion 26, thereby to be almost entirely located in the first tube body 12 of the sleeve 10. In practice, the number of the through hole and the number of the movable member are not limited to plural, but could be merely one.

When the expansion anchoring device 100 is to be used, the movable member 30, which is in the storage state, is put into the recessing hole 200a of the wall 200, and an external force F in a direction away from the sleeve 10 in the axial direction of the sleeve 10 is exerted on the connecting portion 22 of the core member 20, so that the core member 20 moves toward a lower side of FIG. 3, thereby the expansion portion 26 of the core member 20 gradually abuts against the movable members 30 to move the movable members 30 from the storage state to the expansion state. In this way, at least a part of the movable members 30 protrudes out of the through holes 124 to abut against a hole wall of the recessing hole 200a, thereby fixing the expansion anchoring device 100 on the wall 200.

In the current embodiment, an elastic member 40 is further disposed inside the second tube body 14 and fits around the shaft portion 24 of the core member 20, thereby effectively preventing interference from foreign objects and making the core member 20 smoothly move relative to the sleeve 10. In the current embodiment, the second tube body 14 includes a first section 14a and a second section 14b, wherein the elastic member 40 is located in the first section 14a. An inner diameter of the first section 14a is greater than an inner diameter of the second section 14b, and the inner diameter of the second section 14b is slightly greater than an outer diameter of the shaft portion 24 of the core member 20. In this way, a stability when the core member 20 moves relative to the sleeve 10 could be enhanced.

In the current embodiment, the sleeve 10 is formed by the first tube body 12 and the second tube body 14. However, in practice, the sleeve could be integrally formed as a monolithic unit which has a shoulder portion therein for being abutted against by the expansion portion 26 of the core member 20 to position the expansion portion 26.

In an embodiment, the sleeve is integrally formed as a monolithic unit and does not have the shoulder portion, and the core member includes a positioning portion, wherein the positioning portion of the core member is engaged with one of the ends of the expansion portion which does not be connected to the shaft portion, and an outer diameter of the positioning portion is greater than an inner diameter of the sleeve and is smaller than an outer diameter of the sleeve. In this way, when an external force in a direction away from the sleeve in the axial direction of the sleeve is exerted on the connecting portion of the core member, the positioning portion could abut against a tube wall of the sleeve, so that the first end portion of the expansion portion could accurately correspond to the through holes, and the core member could be prevented from detaching from the sleeve.

In an embodiment, the sleeve is integrally formed as a monolithic unit and does not have the shoulder portion, instead, the sleeve has a first tube section and a second tube section (not shown), wherein a diameter of the first tube section is greater than a diameter of the second tube section. In this way, when an external force in a direction away from the sleeve in the axial direction of the sleeve is exerted on the connecting portion of the core member, the expansion portion abuts against a junction between the first tube section and the second tube section, thereby the first end portion could accurately correspond to the through holes, and the core member could be prevented from detaching from the sleeve as well.

In summary, compared to the conventional expansion anchoring device, the expansion anchoring device of the present invention has simpler components which could be easily assembled. In addition, no matter the assembled sleeve or the integrated sleeve, the core member and the movable member, which are located inside the sleeve, could be prevented from adhering the external dust or fine particles, so that the core member could easily and axially move relative to the movable member.

It must be pointed out that the embodiments described above are only some preferred embodiments of the present invention. All equivalent structures which employ the concepts disclosed in this specification and the appended claims should fall within the scope of the present invention.

What is claimed is:

1. An expansion anchoring device comprising:
a sleeve having at least one through hole penetrating through both of an inner peripheral surface and an outer peripheral surface of the sleeve;
a core member passing through the sleeve in a way that the core member is movable in an axial direction of the sleeve, wherein the core member comprises a connecting portion, an expansion portion, and a shaft portion connected to both of the connecting portion and the expansion portion; the connecting portion is located out of the sleeve; the expansion portion is located in the sleeve and comprises a first end portion and a second end portion opposite to the first end portion; an outer diameter of the first end portion is greater than an outer diameter of the second end portion; the second end portion is connected to the shaft portion; and
at least one movable member disposed between the sleeve and the core member, wherein a part of the at least one movable member is located in the at least one through hole.

2. The expansion anchoring device as claimed in claim 1, wherein the at least one through hole of the sleeve comprises a plurality of through holes, and the at least one movable member comprises a plurality of movable members respectively corresponding to the through holes.

3. The expansion anchoring device as claimed in claim 1, wherein a diameter of the at least one through hole gradually increases from the outer peripheral surface toward the inner peripheral surface of the sleeve; at least a part of an outer contour shape of the at least one movable member corresponds to a shape of a hole wall of the at least one through hole.

4. The expansion anchoring device as claimed in claim 1, wherein the sleeve has a shoulder portion protruding out of the inner peripheral surface of the sleeve; the expansion portion is adapted to abut against the shoulder portion, thereby making the first end portion of the expansion portion correspond to the at least one through hole.

5. The expansion anchoring device as claimed in claim 4, wherein the sleeve comprises a first tube body having two ends and a second tube body; one of the ends of the first tube body has the shoulder portion, and the second tube body is connected to one of the ends of the first tube body which has the shoulder portion; the expansion portion of the core member is located in the first tube body.

6. The expansion anchoring device as claimed in claim 5, further comprising an elastic member disposed in the second tube body and fitting around the shaft portion of the core member.

7. The expansion anchoring device as claimed in claim 6, wherein the second tube body comprises a first section and a second section; an inner diameter of the first section is greater than an inner diameter of the second section, and the inner diameter of the second section is slightly greater than an outer diameter of the shaft portion of the core member; the elastic member is located in the first section.

8. The expansion anchoring device as claimed in claim 1, wherein the sleeve is integrally formed as a monolithic unit and has a first tube section and a second tube section; a diameter of the first tube section is greater than a diameter of the second tube section; the expansion portion of the core member is located in the first tube section and is adapted to be abutted against a junction between the first tube section and the second tube section, thereby making the first end portion of the expansion portion correspond to the at least one through hole.
